(19) United States
(12) Patent Application Publication
(10) Pub. No.: US 2026/0139704 A1
(43) Pub. Date: May 21, 2026

(54) RADOME LAP FLANGE HARDWARE WITH MECHANICAL ANTI-ROTATION FEATURE

(71) Applicant: SheerGuard Composite Solutions Inc., Salem, NH (US)

(72) Inventors: Casey Aaron Talbot, Herriman, UT (US); Rajeev Singh, Aurora, CA (US); Seth MIchael Steed, Layton, UT (US)

(73) Assignee: SheerGuard Composite Solutions Inc., Salem, NH (US)

(21) Appl. No.: 19/392,747

(22) Filed: Nov. 18, 2025

Related U.S. Application Data
(60) Provisional application No. 63/721,875, filed on Nov. 18, 2024.

(51) Int. Cl. F16B 37/14; F16B 39/24; F16B 43/00; H01Q 1/42

(52) U.S. Cl. CPC F16B 37/145; F16B 39/24; F16B 43/001; H01Q 1/42

(57) ABSTRACT

A radome panel fastener system may include a first bolt including a first shaft having a first annular cavity. The first shaft may be threaded in a first configuration and the first annular cavity may be threaded in a second configuration. The second annular cavity may be threaded in the first configuration to receive the first shaft threaded therein after passing through a first panel. The retainer may include an anti-rotation mechanism configured to interact with the first panel to inhibit rotation of the retainer relative to the first panel. The system may also include a second bolt including a second shaft. The second shaft may be threaded in the second configuration and may be configured to pass through a second hole in a second panel. The first annular cavity may receive the second shaft therein.

### CROSS-REFERENCE TO RELATED APPLICATIONS

This application claims the benefit of U.S. Provisional Patent Application No. 63/721,875, filed November 18, 2024, and entitled “Radome Lap Flange Hardware with Mechanical Anti-Rotation Feature,” the contents of which are incorporated by reference herein in their entirety.

### FIELD OF THE DISCLOSURE

This disclosure is generally related to the field of radome lap flange hardware and, in particular, to a radome lap flange fastener with a mechanical anti-rotation feature.

### BACKGROUND

Radomes are large spherical enclosures for antennas. A typical radome may be constructed from multiple panels fastened together in a dome or spherical shape. In order to fasten the panels together, a first technician may be positioned on one side (e.g., outside the radome) for holding fastening hardware while a second technician may be positioned on another side (e.g., inside the radome) to tighten the hardware. This can increase the cost of radome installation. Further, radomes may be located in remote un-forgiving locations where the necessary equipment to reach the exterior of the radome may not be available, or the terrain may prohibit the use of the required equipment.

Some proposed solutions rely on proprietary mechanisms such as adhesives, which may lack reliability. Further, these solutions may be only usable for panels of a particular thickness corresponding to the hardware design and may be insufficient for radomes using thicker or thinner panels.

### SUMMARY

Described herein is a novel and unique design for a radome panel fastener system that includes anti-rotation features that are mechanical in nature and where the grip length may be adjustable (to accommodate different panels of varying shapes and thicknesses), which opens possibilities for the design (electrical tuning) of the radome joints. Further, by not having to have technicians on the exterior to hold the hardware for tightening the joints installation may be less expensive and require fewer people and less equipment.

In an embodiment, a radome panel fastener system includes a first bolt that includes a first shaft having a first annular cavity defined therein. The first shaft is male-threaded in a first configuration. The first annular cavity is female-threaded in a second configuration. The first shaft is configured to pass through a first hole in a first panel. The system further includes a retainer having a second annular cavity defined therein. The second annular cavity is female-threaded in the first configuration and is configured to receive the first shaft threaded therein. The retainer includes an anti-rotation mechanism configured to interact with the first panel to inhibit rotation of the retainer relative to the first panel. The system also includes a second bolt having a second shaft. The second shaft is male-threaded in the second configuration and is configured to pass through a second hole in a second panel. The first annular cavity is configured to receive the second shaft threaded therein, thereby attaching the first panel and the second panel.

In some embodiments, the anti-rotation mechanism includes serrations on a surface of the retainer and the serrations are put in contact with a surface of the first panel when the first shaft is threaded in the second annular cavity. In some embodiments, the first configuration is a left-hand threaded configuration and the second configuration is a right-hand threaded configuration. In some embodiments, the first bolt includes a first head and the system further includes a first washer positioned between the first head and the first panel when the first shaft is passed through the first hole, and a second washer positioned between the first washer and the first panel when the first shaft is passed through the first hole. In some embodiments, the first washer is integral with the first bolt. In some embodiments, the second washer is a silicone washer. In some embodiments, the second bolt includes a second head, where the system further includes a third washer configured to sit between the second head and the second panel when the second shaft is passed through the second hole. In some embodiments, the third washer is integral with the second bolt. In some embodiments, a nominal diameter of male threading of the first shaft is 14 mm, a nominal diameter of female threading of the first annular cavity is 10 mm, and a nominal diameter of male threading of the second shaft is 10 mm. In some embodiments, the first panel and the second panel are sandwich radome panels.

In an embodiment, a radome panel fastener system includes a first panel including an overlap flange having a first hole therein. The system further includes a second panel including an underlap flange having a second hole therein, where the overlap flange overlaps the second panel and the underlap flange underlaps the first panel in a complementary configuration that enables a top surface of the first panel to align with a top surface of the second panel. The system also includes a first bolt having a first shaft having a first annular cavity defined therein. The first shaft is male-threaded in a first configuration. The first annular cavity is female-threaded in a second configuration. The first shaft passes through the first hole in the first panel. The system also includes a retainer having a second annular cavity defined therein. The second annular cavity is female-threaded in the first configuration and the first shaft is threaded within the second annular cavity. The retainer includes an anti-rotation mechanism that interacts with the first panel to inhibit rotation of the retainer relative to the first panel. The system includes a second bolt having a second shaft, where the second shaft is male-threaded in the second configuration. The second shaft passes through the second hole in the second panel and is threaded within the first annular cavity, thereby attaching the first panel and the second panel.

In an embodiment, a radome panel fastener method includes inserting a first bolt through a first hole in a first panel. The first bolt includes a first shaft having a first annular cavity defined therein. The first shaft is male-threaded in a first configuration. The first annular cavity is female-threaded in a second configuration. The method includes threading the first shaft into a second annular cavity defined within a retainer. The second annular cavity is female-threaded in the first configuration. The retainer includes an anti-rotation mechanism configured to interact with the first panel to inhibit rotation of the retainer relative to the first panel. The method also includes inserting a second bolt through a second hole in a second panel. The second bolt comprises a second shaft that is male-threaded in the second configuration. The first annular cavity is configured to receive the second shaft threaded therein, thereby attaching the first panel and the second panel.

### BRIEF DESCRIPTION OF THE DRAWINGS

FIG. 1 is a front view of an embodiment of a first bolt for a radome panel fastener system.

FIG. 2 is a sectional view of the embodiment of the first bolt.

FIG. 3 is a bottom view of the embodiment of the first bolt.

FIG. 4 is a top view of an embodiment of a retainer for a radome panel fastener system.

FIG. 5 is a front view of the embodiment of the retainer.

FIG. 6 is a sectional view of the embodiment of the retainer.

FIG. 7 is a perspective view of the embodiment of the retainer.

FIG. 8 is an assembly view of an embodiment of a radome panel fastener system.

FIG. 9 is a sectional assembly view of the embodiment of the radome panel fastener system.

FIG. 10 is a flow chart depicting an embodiment of a radome panel fastener method.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

A radome panel fastener system may include a first bolt, a fastener, and a second bolt. The radome fastener system may be used to fasten a first panel and a second panel at a single joint. By fastening multiple panels in a pattern, a full radome may be constructed.

The first panel and the second panel may be configured to unite at an overlap joint with the first panel overlapping the second panel. The thicknesses of the first panel and the second panel may be selected based on desired electromagnetic properties and the thickness of the overlap joint may be adjusted relative to the thickness of the panels in order to accommodate the overlap with minimal signal interference.

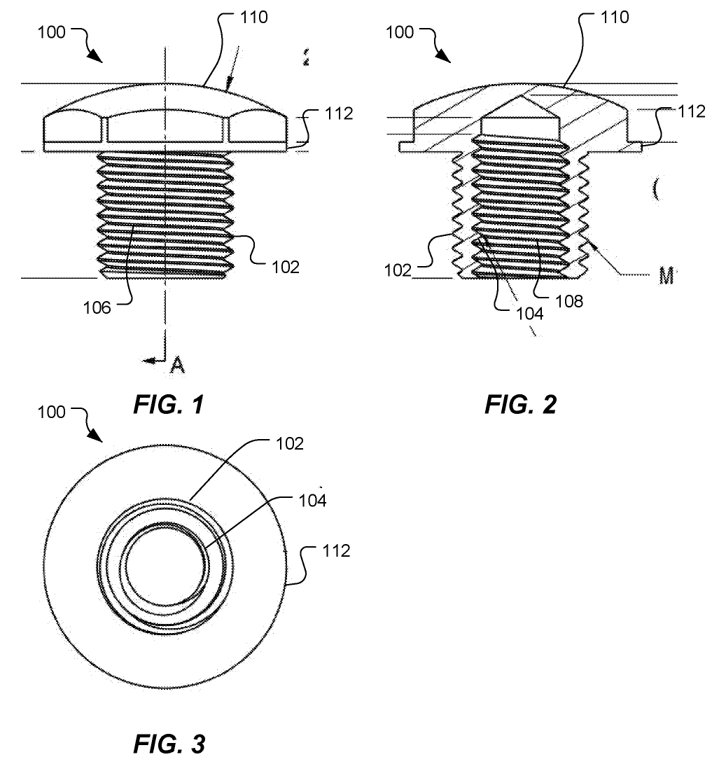

Referring to FIGS. 1-3, an embodiment of a first bolt 100 for a radome panel fastener system is depicted. The first bolt 100 may include a first shaft 102 having a first annular cavity 104 defined therein (shown in FIGS. 2 and 3). The first shaft 102 may also include first threading 106 (shown in FIG. 1), such that the first shaft is male-threaded in a first configuration. As used herein, male-threaded means that the threading is present on an exterior cylindrical surface. The configuration of the threading indicates whether the first bolt 100 is tightened by applying a clockwise torque or a counterclockwise torque. The first annular cavity 104 may include second threading 108 (shown in FIG. 2), such that the first annular cavity is female-threaded in a second configuration. The first configuration may be a left-hand threaded configuration (i.e., tightened by counter-clockwise rotation of the male-threaded bolt) and the second configuration may be a right-hand threaded configuration (i.e., tightened by clockwise rotation of the male-threaded bolt). Other configurations are possible.

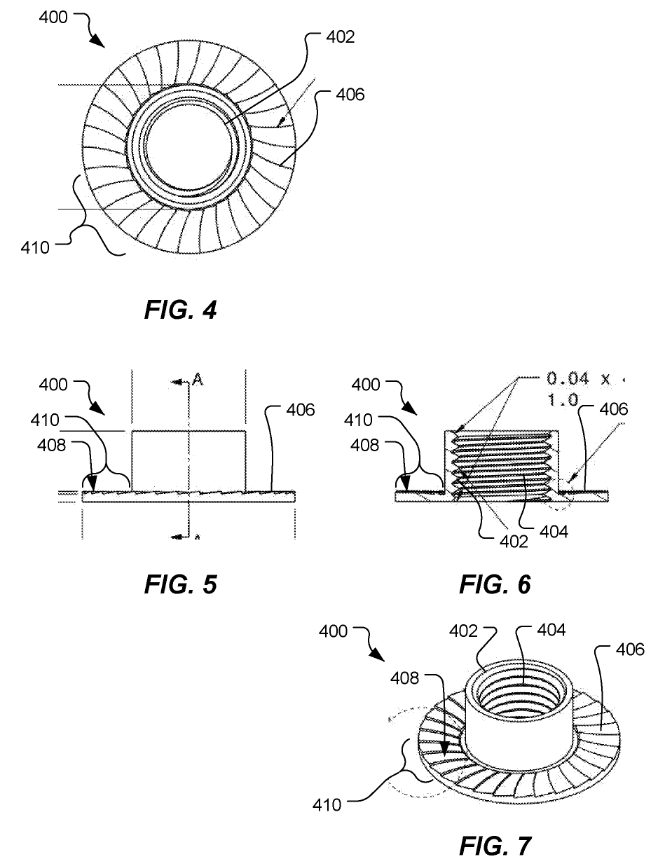

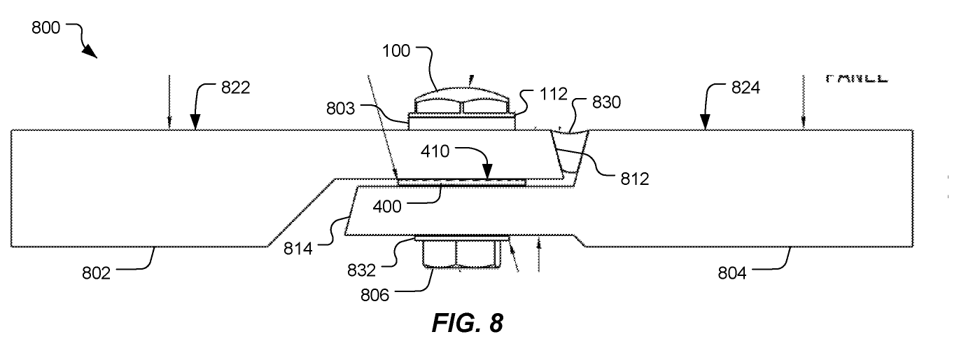

Using a different threading configuration between the outer first threading 106 and the inner second threading 108 may ensure that the first bolt 100 is not loosened from a retainer (described further with respect to FIGS. 4-7) while a second bolt (described further with respect to FIG. 8) is being tightened within the first annular cavity 104. In other words, an angular force in one direction may both: (1) tighten a second bolt being threaded within the first annular cavity 104; and (2) tighten the first bolt 100 within a retainer. A nominal diameter of the first threading 106 of the first shaft 102 may be 14 mm. A nominal diameter of the second threading 108 of the first annular cavity 104 may be 10 mm.

The first bolt 100 may include a first head 110. A first washer 112 may be positioned below the head 110. The first washer 112 may be integral with the first bolt. In other words, the first bolt 100 and the first washer 112 may form one continuous piece. In some embodiments, the first head 110 may be a 22 mm hex head. The first shaft 102 may be male threaded with a standardized M14 left-hand male thread. The first annular cavity 104 may be threaded with a standardized M10 right-hand female threading.

Referring to FIGS. 4-7, an embodiment of a retainer 400 is depicted. The retainer 400 may be shaped as a flanged sleeve or bolt having a second annular cavity 402 defined therein. The second annular cavity 402 may include third threading 404 (shown in FIGS. 6 and 7), which may be female-threaded in the first configuration (to enable compatibility with the first threading 106 of the first bolt 100). In some embodiments, the second annular cavity 402 may be threaded with a standardized M14 left-hand female thread. The second annular cavity 402 may be configured to receive the first shaft 102 threaded therein.

The retainer 400 may include an anti-rotation mechanism 406. The anti-rotation mechanism 406 may be configured to interact with a panel to which it may come in contact to inhibit rotation of the retainer relative to the panel. In an embodiment described herein, the anti-rotation mechanism 406 may include serrations 410 on a surface 408 of the retainer 400. The serrations 410 may be put in contact with a surface of a panel when the first shaft 102 of the first bolt 100 is threaded in the second annular cavity 402. Tightening the first bolt 100 into the retainer 400, may create a compression force pressing the serrations 410 against the panel.

Referring to FIG. 8, an assembly view of a radome fastener system 800 is depicted. The radome fastener system 800 may include a first panel 802 and a second panel 804 to be fastened together. The first panel 802 and the second panel 804 may be sandwich radome panels. Although, other applications are possible.

The first panel 802 may have an overlap flange 812 and the second panel 804 may have an underlap flange 814. The first panel 802 and the second panel 804 may fit together in a complementary fashion such that a surface 822 of the first panel 802 is even and flush with a surface 824 of the second panel 804 when the panels are connected. The first bolt 100 may pass through the overlap flange 812 of the first panel 802 and may be retained in its position by the retainer 400. A second washer, which may be a silicone washer 803, may be positioned between the first bolt 100 and the first panel 802. A second bolt 806 may pass through the underlap flange 814 of the second panel 804 in order to retain the second panel 804 in its position relative to the first panel 802. The system 800 may include a third washer 832 to press firmly against the second panel 804 when the second bolt 806 is threaded into the first bolt 100. In some embodiments the third washer 832 may be integral to the second bolt 806.

A sealant 830 may be applied between the first panel 802 and the second panel 804 to prevent water from seeping through the joint. Additionally, the silicone washer 803 may be positioned between the first washer 112 and the surface 822 of the first panel 802. The silicone washer 803 may provide additional water resistance.

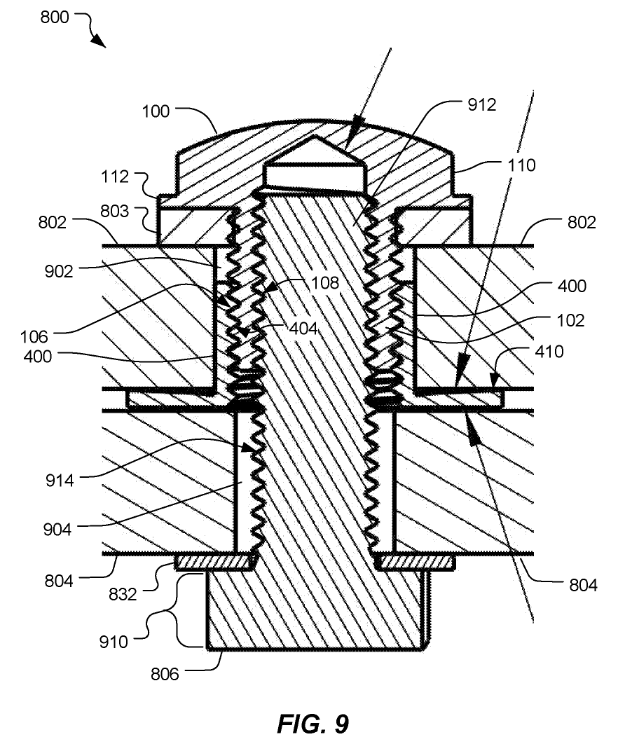

Referring to FIG. 9, a sectional assembly view of the radome fastener system 800 is depicted. In the depiction of FIG. 9, the first shaft 102 of the first bolt 100 has been passed through a first hole 902 in the first panel 802. The retainer 400 has been threaded with the first bolt 100 such that the first threading 106 of the first bolt 100 is fastened with the third threading 404 of the retainer 400. The silicone washer 803 may be positioned between the first washer 112 and the first panel 802. As the first head 110 of the first bolt 100 is tightened, the silicone washer 803 may form a seal the prevent water seepage. The retainer 400 may hold the first bolt 100 in position within the first panel 802. Further, the serrations 410 may prevent the retainer 400 from rotating relative to the first panel 802.

The second bolt 806 may include a second shaft 912, which may be passed through a second hole 904 in the second panel 804 and threaded into the first bolt 100 such that it is threaded into the second threading 108. Thus, the second shaft 912 may include fourth threading 914 that is male-threaded in the second configuration (e.g., right-hand threaded) for compatibility with the second threading 108. Because the second shaft 912 is threaded in an opposite configuration as the first shaft 102 of the first bolt 100, as the second bolt 806 is tightened within the first bolt 100, the first bolt is tightened within the retainer 400. The second bolt 806 may include a second bolt head 910 for tightening the second bolt 806 within the first bolt 100. The third washer 832 may hold the second panel 804 in a fixed position relative to the first panel 802. A nominal diameter of the third threading of the second shaft may be 10 mm. In some embodiments, second bolt may be a standardized M10 right-hand threaded bolt.

Attaching to panels may occur as follows. The first shaft 102 of the first bolt 100 may be passed through the first washer 112 (unless the first washer 112 is integral with the first bolt 100), the second washer or silicone washer 803, and the first hole 902 in the first panel 802. The first shaft 102 of the first bolt 100 may then be threaded into the second annular cavity 402 of the retainer 400. The serrations 410 are then put in contact with and tightened against the first panel 802 to prevent rotation of the retainer 400.

With the first bolt 100 and retainer 400 held in place, the second bolt 806 may be passed through the third washer 832 (unless the third washer 832 is integral with the second bolt 806) and through the second hole 904 in the second panel 804 and threaded into the first annular cavity 104 of the first bolt 100. Because the first bolt 100 may be left hand threaded and the second bolt 806 may be right hand threaded, the first bolt 100 may resist unthreading while the second bolt 806 is threaded therein. Once the second bolt 806 is threaded into the first bolt 100, the first and second panels 802, 804 are attached.

Some benefits of the embodiments described herein are: (1) anti rotation may be achieved without the use of adhesives (which are not resilient); (2) sealing may be achieved by compressing the silicone washer 803, resulting in a resilient seal that is self-healing if excessive torque is applied; (3) the compressed silicone washer 803, also allows the seal to be maintained after panel installation where alignment pins are used and which tend to fracture typically brittle adhesive seals and can result in water being pulled into the radome via capillary action; (4) threading of the first bolt 100 into the retainer 400 means the assembly grip length can vary and accommodate variations in overlap flange thickness, which gives more design flexibility and makes the design more friendly to manufacturing tolerances; (5) opposite threading ensures the assembly doesn’t loosen as the second bolt 806 is inserted and tightened; (6) the left handed threading is also advantageous because the effectiveness of the serrations is tied to a normal force applied between the serrated surface and the interior surface of the overlap joint, meaning as more torque is applied to the fastener assembly the normal force increases due to tightening of the left-hand thread increasing its capacity to resist the applied torque; (7) the retainer 400 may ensure a uniform air gap between the overlap flange and underlap mating surfaces; and (8) because the described fastening system is designed with standardized bolt heads and threading, no specialized tools or equipment may be necessary for installation. Other benefits and advantages may exist.

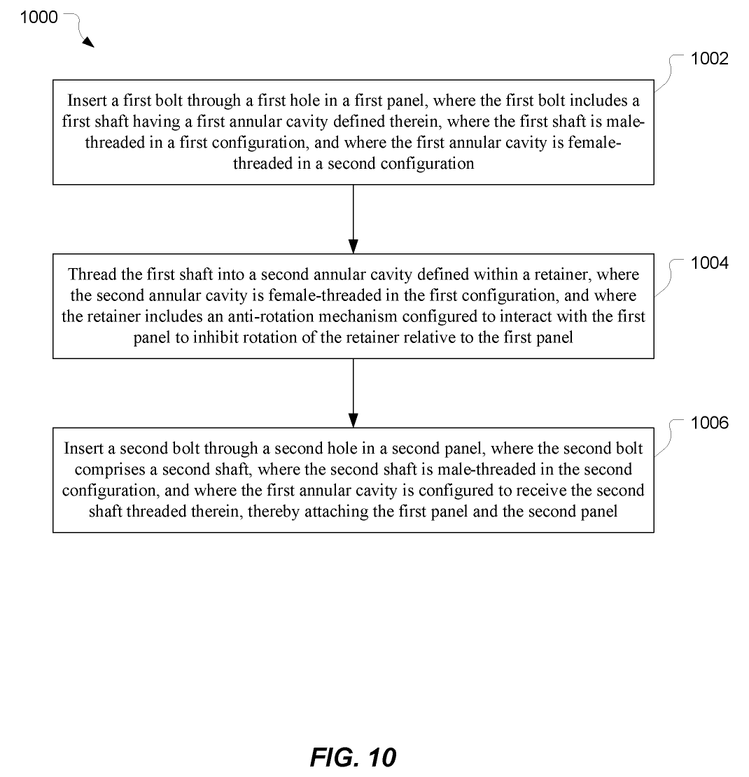

Referring to FIG. 10, a panel fastener method 1000 may include inserting a first bolt through a first hole in a first panel, where the first bolt includes a first shaft having a first annular cavity defined therein, where the first shaft is male-threaded in a first configuration, and where the first annular cavity is female-threaded in a second configuration, at 1002. For example, the first bolt 100 may be inserted through the first hole 902 in the first panel 802.

The method 1000 may also include threading the first shaft into a second annular cavity defined within a retainer, where the second annular cavity is female-threaded in the first configuration, and where the retainer includes an anti-rotation mechanism configured to interact with the first panel to inhibit rotation of the retainer relative to the first panel, at 1004. For example, the first shaft 102 may be threaded into the second annular cavity 402.

The method 1000 may include inserting a second bolt through a second hole in a second panel, where the second bolt comprises a second shaft, where the second shaft is male-threaded in the second configuration, and where the first annular cavity is configured to receive the second shaft threaded therein, thereby attaching the first panel and the second panel, at 1006. For example, the second bolt 806 may inserted through the second hole 904 in the second panel 804.

In some embodiments, steps 1002 and 1004 may occur at a factory or workshop location, on the ground, or in another safe location, and step 1006 may be the only step performed in the field or on site. Among other things, such embodiments enable labor savings and increased safety by simply installing the second bolt (e.g., bolt 806) in the field and from the interior of a radome.

Although various embodiments have been shown and described, the present disclosure is not so limited and will be understood to include all such modifications and variations as would be apparent to one skilled in the art.

What is claimed is:

1. A radome panel fastener system comprising:
a first bolt comprising a first shaft having a first annular cavity defined therein, wherein the first shaft is male-threaded in a first configuration, wherein the first annular cavity is female-threaded in a second configuration, and wherein the first shaft is configured to pass through a first hole in a first panel;
a retainer having a second annular cavity defined therein, wherein the second annular cavity is female-threaded in the first configuration, wherein the second annular cavity is configured to receive the first shaft threaded therein, and wherein the retainer includes an anti-rotation mechanism configured to interact with the first panel to inhibit rotation of the retainer relative to the first panel; and
a second bolt comprising a second shaft, wherein the second shaft is male-threaded in the second configuration, wherein the second shaft is configured to pass through a second hole in a second panel, and wherein the first annular cavity is configured to receive the second shaft threaded therein, thereby attaching the first panel and the second panel.

2. The system of claim 1, wherein the anti-rotation mechanism includes serrations on a surface of the retainer, and wherein the serrations are put in contact with a surface of the first panel when the first shaft is threaded in the second annular cavity.

3. The system of claim 1, wherein the first configuration is a left-hand threaded configuration, and wherein the second configuration is a right-hand threaded configuration.

4. The system of claim 1, wherein the first bolt includes a first head, and wherein the system further comprises:
a first washer positioned between the first head and the first panel when the first shaft is passed through the first hole: and
a second washer positioned between the first washer and the first panel when the first shaft is passed through the first hole.

5. The system of claim 4, wherein the first washer is integral with the first bolt.

6. The system of claim 4, wherein the second washer is a silicone washer.

7. The system of claim 1, wherein the second bolt includes a second head, and wherein the system further comprises a third washer configured to sit between the second head and the second panel when the second shaft is passed through the second hole.

8. The system of claim 7, wherein the third washer is integral with the second bolt.

9. The system of claim 1, wherein a nominal diameter of male threading of the first shaft is 14 mm, wherein a nominal diameter of female threading of the first annular cavity is 10 mm, and wherein a nominal diameter of male threading of the second shaft is 10 mm.

10. The system of claim 1, wherein the first panel and the second panel are sandwich radome panels.

11. A radome panel fastener system comprising:
a first panel comprising an overlap flange having a first hole therein;
a second panel comprising an underlap flange having a second hole therein, wherein the overlap flange overlaps the second panel and the underlap flange underlaps the first panel in a complementary configuration that enables a top surface of the first panel to align with a top surface of the second panel;
a first bolt comprising a first shaft having a first annular cavity defined therein, wherein the first shaft is male-threaded in a first configuration, wherein the first annular cavity is female-threaded in a second configuration, and wherein the first shaft passes through the first hole in the first panel;
a retainer having a second annular cavity defined therein, wherein the second annular cavity is female-threaded in the first configuration, wherein the first shaft is threaded within the second annular cavity, and wherein the retainer includes an anti-rotation mechanism that interacts with the first panel to inhibit rotation of the retainer relative to the first panel; and
a second bolt comprising a second shaft, wherein the second shaft is male-threaded in the second configuration, wherein the second shaft passes through the second hole in the second panel, and wherein the second shaft is threaded within the first annular cavity, thereby attaching the first panel and the second panel.

12. The system of claim 11, wherein the anti-rotation mechanism includes serrations on a surface of the retainer, and wherein the serrations are put in contact with a surface of the first panel when the first shaft is threaded in the second annular cavity.

13. The system of claim 11, wherein the first configuration is a left-hand threaded configuration, and wherein the second configuration is a right-hand threaded configuration.

14. The system of claim 11, wherein the first bolt includes a first head, wherein the second bolt includes a second head, and wherein the system further comprises:
a first washer positioned between the first head and the first panel when the first shaft is passed through the first hole:
a second washer positioned between the first washer and the first panel when the first shaft is passed through the first hole; and
a third washer configured to sit between the second head and the second panel when the second shaft is passed through the second hole.

15. The system of claim 14, wherein the first washer is integral with the first bolt, and wherein the third washer is integral with the second bolt.

16. The system of claim 14, wherein the second washer is a silicone washer.

17. The system of claim 11, further comprising a sealant positioned between the first panel and the second panel.

18. The system of claim 11, wherein the first panel and the second panel are sandwich radome panels.

19. A radome panel fastener method comprising:
inserting a first bolt through a first hole in a first panel, wherein the first bolt comprises a first shaft having a first annular cavity defined therein, wherein the first shaft is male-threaded in a first configuration, and wherein the first annular cavity is female-threaded in a second configuration;
threading the first shaft into a second annular cavity defined within a retainer, wherein the second annular cavity is female-threaded in the first configuration, and wherein the retainer includes an anti-rotation mechanism configured to interact with the first panel to inhibit rotation of the retainer relative to the first panel; and
inserting a second bolt through a second hole in a second panel, wherein the second bolt comprises a second shaft, wherein the second shaft is male-threaded in the second configuration, and wherein first annular cavity is configured to receive the second shaft threaded therein, thereby attaching the first panel and the second panel.

20. The method of claim 19, wherein the anti-rotation mechanism includes serrations on a surface of the retainer, and wherein the serrations are put in contact with a surface of the first panel when the first shaft is threaded in the second annular cavity.
